(19) United States
(12) Patent Application Publication
(10) Pub. No.: US 2015/0076100 A1
(43) Pub. Date: Mar. 19, 2015

(54) LOAD MONITORING SYSTEM FOR A LIFTING SYSTEM

(71) Applicant: Caterpillar Inc., Peoria, IL (US)

(72) Inventors: Gabriel J. Ellicott, Peoria Heights, IL (US); Monte A. Crossman, Astoria, IL (US)

(73) Assignee: Caterpillar Inc., Peoria, IL (US)

(21) Appl. No.: 14/552,516

(22) Filed: Nov. 25, 2014

(51) Int. Cl. B66C 13/18; B66C 23/90

(52) U.S. Cl. CPC B66C 13/18; B66C 23/905
USPC 212/278

(57) ABSTRACT

A load monitoring system for a lifting system that includes a lifting device is provided. The load monitoring system includes a lifting link assembly and a controller. The lifting link assembly includes a link body, a strain sensor, and a radio frequency identification (RFID) device. The link body is structured and arranged to couple the lifting device to a load. The strain sensor is fixed to the link body and is configured to generate a signal corresponding to the load. The RFID device is fixed to the link body and is configured to receive the signal. Further, the controller is in communication with the RFID device, and is configured to receive the signal from the RFID device and initiate a safe lifting protocol in response to the signal attaining a pre-determined threshold value.

### TECHNICAL FIELD

The present disclosure relates to lifting systems. More particularly, the present disclosure relates to a load monitoring system for a lifting system.

### BACKGROUND

During a manufacturing process, a product is typically advanced through a plurality of manufacturing stations within a manufacturing chain. Specifically, the product is transported through each of the manufacturing stations along a transportation system. The transportation systems may include overhead cranes, which are designed to lift and transport loads, within or between manufacturing stations. Overhead cranes, particularly those of the larger type, most commonly embody a bridge girder supported on trucks. The trucks are movable over runway beams supported on columns. In addition, the overhead crane includes one or more lifting components structured to lift loads for transportation. The lifting component, such as hook, strap, magnet, and/or the like, is coupled to a trolley frame slidably mounted on the bridge girder. Such lifting components may have rated capacities for a favorable lift operation. Further, during the lift operation, the lifting components may be subjected to stresses due to the loads being lifted by the lifting components. It may be considered that during the lift operation, the strain caused upon the lifting component, due to the lifted loads, may exceed a pre-determined threshold value. Since, the hoist devices have rated capacities, lifting the loads beyond the rated capacities may impose considerable stress on the lifting component and may result in unfavorable consequences.

U.S. Publication No. 2010/0044332 discloses a method to monitor overstress conditions experienced by a crane component. In the overstress condition, a wireless signal that indicates an overstress condition is generated. In response to receipt of the wireless signal, a record of the overstress condition is stored in a storage module mechanically coupled with a crane component. However, the reference does not discuss a provision for an active overstress prevention based on rated capacities of lifting components.

### SUMMARY OF THE INVENTION

The present disclosure relates to a load monitoring system for a lifting system. The lifting device is configured to lift a load during a lifting operation.

In accordance with the present disclosure, the load monitoring system includes a lifting link assembly and a controller. The lifting link assembly includes a link body, a strain sensor, and a radio frequency identification (RFID) device. The link body is structured and arranged to couple the lifting device to the load. The strain sensor is fixed to the link body and is configured to generate a signal corresponding to the load. The RFID device is fixed to the link body and is configured to receive the signal. Further, the controller is in communication with the RFID device, and is configured to receive the signal from the RFID device and initiate a safe lifting protocol in response to the signal attaining a pre-determined threshold value.

### BRIEF DESCRIPTION OF THE DRAWINGS

FIG. 1 is a perspective view of a lifting system engaged with a load, in accordance with the concepts of the present disclosure;

FIG. 2 is a schematic view of a view of a first embodiment of a lifting link assembly of the lifting system of FIG. 1, illustrating a strain sensor and an RFID device in an enlarged view of the encircled area of an adhesive layer on the lifting link assembly, in accordance with the concepts of the present disclosure;

FIG. 3a is a perspective view of a second embodiment of a lifting link assembly for use within the lifting system of FIG. 1, which is embedded with a strain sensor and an RFID device, in accordance with the concepts of the present disclosure;

FIG. 3b is a perspective view of a third embodiment of a lifting link assembly for use within the lifting system of FIG. 1, which is embedded with a strain sensor and an RFID device, which are illustrated by a cut-out, in accordance with the concepts of the present disclosure;

FIG. 3c is a perspective view of a fourth embodiment of a lifting link assembly for use within the lifting system of FIG. 1, which is embedded with a strain sensor and an RFID device, which are illustrated by a cut-out, in accordance with the concepts of the present disclosure;

FIG. 4 is a perspective view of a fifth embodiment of a lifting link assembly with a lifting eye embedded with the strain sensor and the RFID device illustrating a strain sensor and an RFID device in an enlarged view of the encircled area of the lifting eye of the lifting link assembly, in accordance with the concepts of the present disclosure; and

FIG. 5 is a block diagram of a load monitoring system for the lifting system of FIG. 1, in accordance with the concepts of the present disclosure.

### DETAILED DESCRIPTION

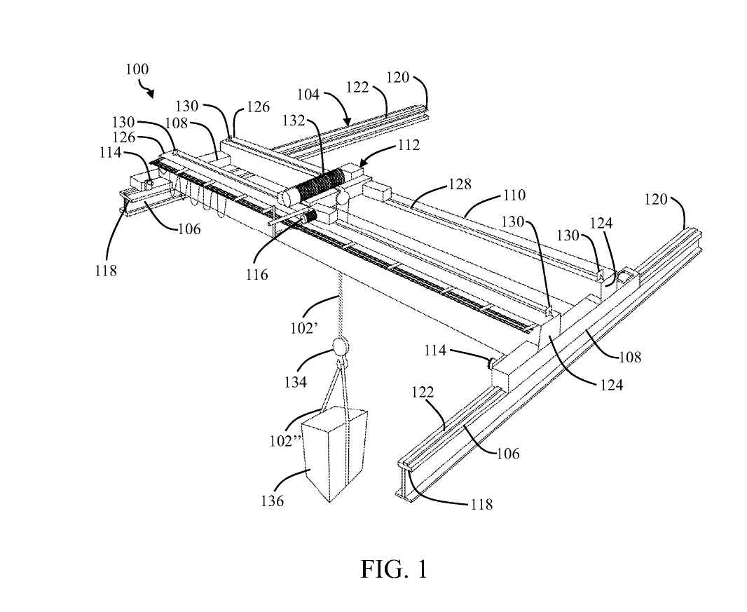

Referring to FIG. 1, there is shown a lifting system 100. The lifting system 100 may include a plurality of lifting link assemblies 102 mounted to a lifting device 104. The plurality of lifting link assemblies 102 includes the lifting link assembly 102′ and the lifting link assembly 102″. The lifting device 104 may include a pair of runway beams 106, a pair of trucks 108, an idler girder 110, a trolley frame 112, a pair of bridge drives 114, and a pair of trolley drives 116 as is customary. The runway beams 106 may be supported on columns that may be independent of, attached to, and/or integral with the building columns of a manufacturing facility (not shown). The runway beam 106 includes a first end 118 and second end 120, which defines a runway rail 122. The runway rail 122 is structured to allow the pair of trucks 108 to slide between the first end 118 and the second end 120. Each truck 108 includes the bridge drive 114 to facilitate synchronization of sliding of the truck 108.

The idler girder 110 is attached between the pair of the trucks 108. The idler girder 110 includes a first end 124 and a second end 126, which defines a bridge rail 128. The first end 124 and the second end 126 include a plurality of end stops 130. Further, the bridge rail 128 is structured to facilitate slidable movement of the trolley frame 112. The movement of the trolley frame 112 may slide over the bridge rail 128; however, such movement of the trolley frame 112 is restricted by the end stops 130 placed at the first end 124 and the second end 126. The trolley frame 112 includes a hoist 132 and the pair of trolley drives 116. The trolley drives 116 on each side of the trolley frame 112 facilitate the slidable movement of the trolley frame 112 over the bridge rail 128 between the first end 124 and the second end 126 of the idler girder 110.

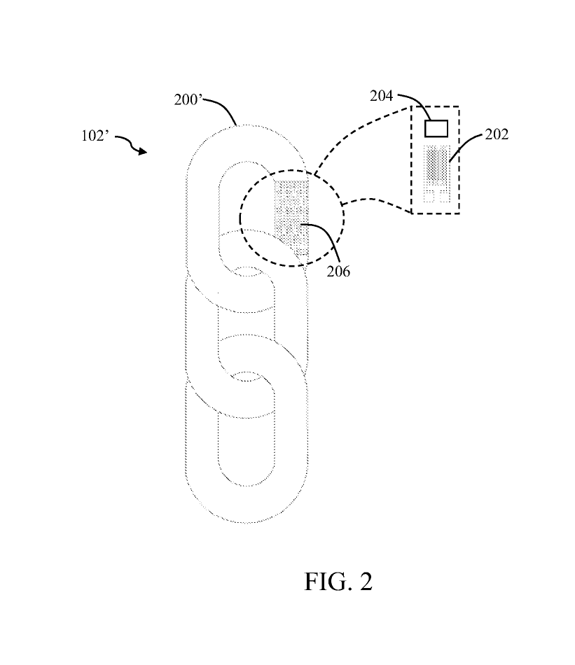

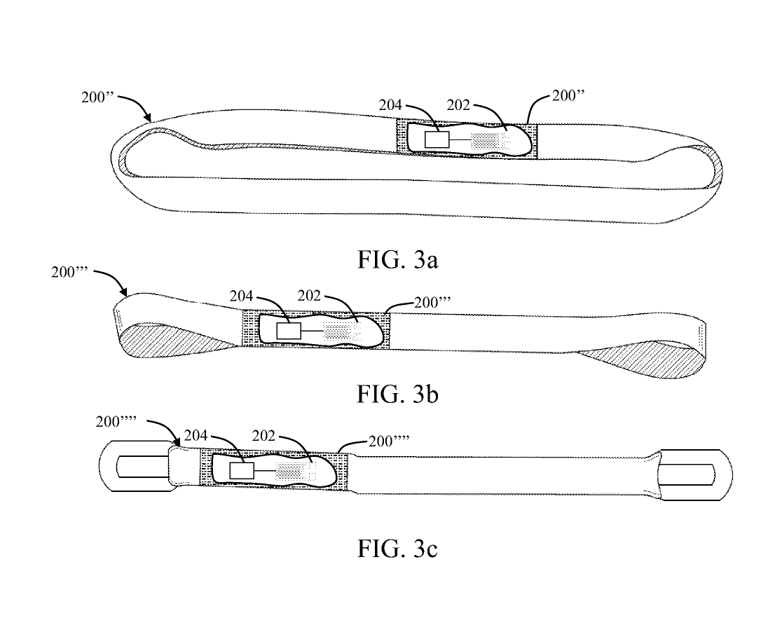

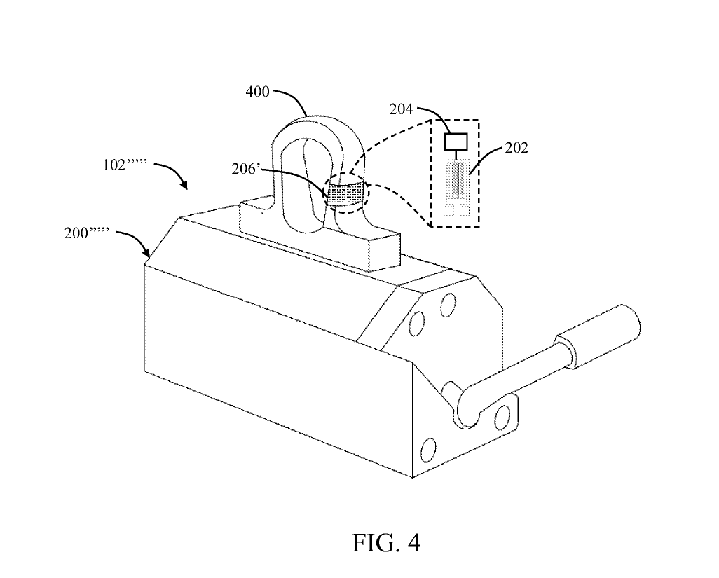

Further, the lifting device 104 may be coupled to a hook 134, via the lifting link assembly 102′. The lifting link assembly 102′ may be a strap, cord or chain member, for example, or any portion of the aforesaid hereof, fitted with a force sensing and communication componentry as will be described herein below. Further, as seen in FIG. 1, the hook 134 carries a load 136, such as a partially assembled transmission for transit to an adjacent build station, for example, via the lifting link assembly 102″, which is tied around the load 136. The lifting link assembly 102″ facilitates engagement with the lifting device 104 and transmits the weight of the load 136 to the lifting device 104. The lifting link assembly 102′ may be connected in series, with at least one of the lifting link assemblies 102″, 102″′, 102″″, and 102″″ (as shown in FIGS. 2-4). In exemplary embodiments, the lifting link assembly 102′ includes a link body 200′, in the form of a chain link (as shown in FIG. 2). The lifting link assemblies 102″, 102″′, 102″″ include respective link bodies 200″, 200″′, 200″″, which may be straps (as shown in FIGS. 3a, 3b, and 3c). Alternatively, the lifting link assembly 102″″′ includes a link body 200″″′, which may be in the form of a lifting lug (as shown in FIG. 4).

Referring to FIG. 2, there is shown the lifting link assembly 102′ having a link body 200′. The lifting link assembly 102′ is structured to have a strain sensor 202 and an RFID device 204 fixed thereto. The strain sensor 202 and the RFID device 204 may be fixed to the lifting link assembly 102′, via an adhesive or glue, as is customary. As illustrated in FIG. 2, an adhesive layer 206 is applied on the link body 200′, to facilitate attachment of the strain sensor 202 and the RFID device 204. An enlarged view of an encircled portion of the adhesive layer 206 is depicted to illustrate the strain sensor 202 and the RFID device 204. The strain sensor 202 is placed on the lifting link assembly 102′ to measure the strain generated in the lifting link assembly 102′, while the load 136 (shown in FIG. 1) is lifted during a lift operation. The strain sensor 202 generates a signal that corresponds to the strain in the lifting link assembly 102′, which in turn corresponds to the weight of the load 136 (shown in FIG. 1). The strain sensor 202 is coupled to the RFID device 204, which is adapted to receive the signal from the strain sensor 202, and thus, communicate with the lifting device 104.

Referring to FIG. 3a, there is shown a second embodiment of the lifting link assembly 102″. The lifting link assembly 102″ may be positioned in series with the lifting link assembly 102′. The lifting link assembly 102″ includes a link body 200″, which is a single length of high tension material, such as a nylon composite, for example. The strain sensor 202 and the RFID device 204 may be embedded in the link body 200″ to ensure stretch or deflection of the lifting link assembly 102″. The strain sensor 202 generates a signal corresponding to a strain experienced by the lifting link assembly 102″, while the object is lifted.

Referring to FIG. 3b, there is shown a third embodiment of the lifting link assembly 102″′. The lifting link assembly 102′″ may be positioned in series with the lifting link assembly 102′. The lifting link assembly 102″′ includes a link body 200′″, which is a strap having an eye and eye structure. The link body 200″′ is composed of high tension material, such as a nylon composite, for example. The strain sensor 202 and the RFID device 204 may be embedded in the link body 200″′ to ensure stretch or deflection of the lifting link assembly 102″′. The strain sensor 202 generates the signal corresponding to the strain experienced by the lifting link assembly 102″′ while the object is lifted.

Referring to FIG. 3c, there is shown a fourth embodiment of the lifting link assembly 102″″. The lifting link assembly 102″″ may be positioned in series with the lifting link assembly 102′. The lifting link assembly 102″″ includes a link body 200″″, which is a strap having unilink structure. The link body 200″″ is composed of high tension material, such as a nylon composite, for example. The strain sensor 202 and the RFID device 204 may be embedded in the link body 200″″ to ensure stretch or deflection of the lifting link assembly 102″″. The strain sensor 202 generates the signal corresponding to the strain experienced by the lifting link assembly 102″″ while the object is lifted.

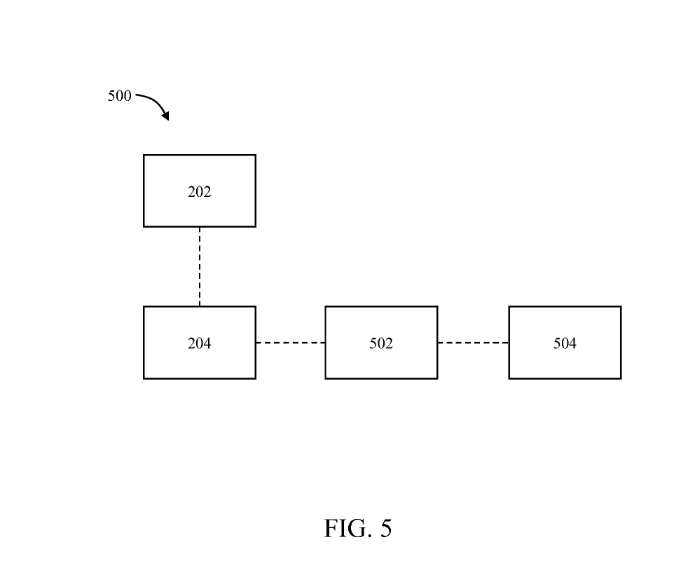

The strain sensor 202 is in communication with the RFID device 204. The strain measured by the strain sensor 202 is wirelessly communicated to a controller (shown as 502 in FIG. 5) to effect a safe lift protocol for the lifting device 104 via the RFID device 204. A safe lift protocol may be one of halting any further movement of the load 136 (shown in FIG. 1) and an operator alert, for example.

Referring to FIG. 4, there is shown a fifth embodiment of the lifting link assembly 102″″′, which is a magnet assembly. The lifting link assembly 102″″′ may include the link body 200″″″ and a lifting eye 400, which is coupled to the strain sensor 202 and the RFID device 204, via the adhesive layer 206′. The strain sensor 202 may measure the load 136 (shown in FIG. 1) experienced by the lifting link assembly 102″″′ while performing the lift operation. Since, the strain sensor 202 is in control communication with the RFID device 204, the strain measured by the strain sensor 202 is communicated to the lifting device 104, via the RFID device 204.

Referring to FIG. 5, there is shown a block diagram of a load monitoring system 500 for the lifting system 100. The load monitoring system 500 may include a controller 502, a display 504, the strain sensor 202, and the RFID device 204. The controller 502 may be located on the lifting device 104. The controller 502 may be adapted to monitor the lift operation, based on the communication with the lifting link assembly 102, via the strain sensor 202 and the RFID device 204. The controller 502 may be coupled to the display 504, which is positioned in the lifting device 104. The display 504 may be a graphical user interface, a touch screen, and/or the like.

### INDUSTRIAL APPLICABILITY

In operation, during the lift operation, the load 136 is engaged with the lifting link assembly 102, which includes the strain sensor 202 and the RFID device 204. As the lifting device 104 lifts the load 136 off a rest position, the strain sensor 202 in the lifting link assembly 102 stretches in length. By this means, there is an increase in electrical resistance. This results in generation of the signal that corresponds to the strain experienced by the strain sensor 202. The signal thus generated is communicated to the RFID device 204, which is connected to the strain sensor 202. The RFID device 204 then sends the signal to the controller 502. The controller 502 infers the strain information, which is based on the signal and determines if the measured strain is equal to the pre-determined threshold value for the respective lifting link assembly 102. The pre-determined threshold value corresponds to the strain beyond which the lifting link assembly 102 may fail. Thus, upon determination that the strain in the strain sensor 202 of the lifting link assembly 102 has reached the pre-determined threshold value, the controller 502 initiates a safe lifting protocol and sends signals to the lifting device 104 to disable or stop the lift operation. The controller 502 also sends alert signals to the display 504 for operator information. The display 504 is adapted to visually represent data that pertains to the lift operation received by the controller 502. The alert signal may be accompanied with sound alerts. In an embodiment, the controller 502 disables all navigation functions, except for the function that lowers the load 136.

For example, the lifting system 100 includes the lifting link assembly 102′ and 102″. In such case, the lifting link assembly 102″ may fail at a lower load as compared to the lifting link assembly 102′. This implies that the pre-determined threshold value for the lifting link assembly 102″ is lower than the pre-determined threshold value of the lifting link assembly 102′. Thus, in this case, the controller 502 gives priority to a lower pre-determined threshold value. The lower pre-determined threshold value corresponds to the pre-determined threshold value of lifting link assembly 102″. This helps in prevention of the failure of the lifting link assembly 102″, while lifting the load 136. This way failure of the weakest lifting link assembly 102 is prevented. In an embodiment, the RFID device 204 is coupled to loads, fixtures, pallets, and actual parts involved in the lift operation. In such case, an RFID reader is employed to extract information regarding the weight of the loads, fixtures, pallets, and/or actual parts (such as clamping/holding devices) and pre-determined threshold strain value for each of the loads, fixtures, pallets, and/or actual parts. Further, this may indicate whether the loads, fixtures, pallets, actual parts, and/or the current lifting link assembly 102 are favorable for the lift, which prevents any unfavorable results. Accordingly, the load monitoring system 500 notifies the operator about the lift operation via the display 504. This implies that the load monitoring system 500 notifies the operator if all conditions are optimum for the lift operation or what units need to be replaced to complete the lift operation, for example, if the lifting link assembly 102 does not meet weight limits or the load exceeds limit for the lifting device 104. The proposed load monitoring system 500 intends to provide a real-time monitoring of the load 136 to increase productivity of the lift operations. The disclosed load monitoring system 500 makes use of strain sensors which provides information of stresses in the lifting link assemblies 102. On reaching, the pre-determined threshold strain value, the disclosed system stops the raising of the lifting link assembly 102, thereby halting the lift operation. The existing systems calculate favorable total lift weight based on weight of each object to be lifted.

The many features and advantages of the disclosure are apparent from the detailed specification, and, thus, it is intended by the appended claims to cover all such features and advantages of the disclosure, which fall within the true spirit and scope thereof. Further, since numerous modifications and variations will readily occur to those skilled in the art, it is not desired to limit the disclosure to the exact construction and operation illustrated and described, and, accordingly, all suitable modifications and equivalents may be resorted to that fall within the scope of the disclosure.

What is claimed is:

1. A load monitoring system for a lifting device, the lifting device is configured to lift a load during a lifting operation, the load monitoring system comprising:
a lifting link assembly including:
a link body structured and arranged to couple the lifting device to the load;
a strain sensor fixed to the link body, the strain sensor configured to generate a signal corresponding to the load; and
a radio frequency identification (RFID) device fixed to the link body, the RFID device configured to receive the signal;
a controller in communication with the RFID device, the controller configured to receive the signal from the RFID device and initiate a safe lifting protocol in response to the signal attaining a pre-determined threshold value.
